(19) United States
(12) Patent Application Publication
(10) Pub. No.: US 2006/0149801 A1
(43) Pub. Date: Jul. 6, 2006

(54) Method of encoding a signal into a bit stream

(76) Inventor: Ihor Kirenko, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/562,358

(22) PCT Filed: Jun. 28, 2004
(86) PCT No.: PCT/IB04/02157

§ 371 Date: Dec. 27, 2005

(30) Foreign Application Priority Data
Jun. 30, 2003 (EP) 03300044.9

(51) Int. Cl. G06F 15/00

(52) U.S. Cl. 708/200

(57) ABSTRACT

The invention relates to a method of encoding an input signal into an output bit stream (BS). Said method comprises steps of applying (1) a transformation to a block of values (BV) in order to get a transformed block (T), scanning (2) the coefficients (C₁-C₁) of a transformed block (TB) according to a coefficient scanning order, splitting (3) a scanned coefficient (Cᵢ) into K groups of bits (C_{i,1}-C_{i,K}) such that at least a group of bits comprise at least 2 bits and such that said scanned coefficient (Cᵢ) is the concatenation of the K groups of bits, entropy coding (4) a kth group of bits (C_{i,k}) using entropy codes into a kth entropy coded group of bits (EC_{i,k}) and forming (5) a block bit stream (BBS) from the K entropy coded groups of bits of the scanned coefficients of the transformed block, said output bit stream (BS) comprising said block bit stream (BBS).

### FIELD OF THE INVENTION

The invention relates to a method of encoding a signal, said signal comprising blocks of values, into a bit stream. The invention also relates to a video encoder using such an encoding method. The invention also relates to a method of decoding such a bit stream. The invention also relates to a video decoder implementing such a decoding method. The invention finally relates to a video trans-coder for trans-coding a first bit stream into such a bit stream.

The invention is particularly relevant in the domain of compression, transmission and storage of video for multimedia systems.

### DOMAIN OF THE INVENTION

Patent Application published under number WO01/17268A1 discloses a method of and a device for coding a signal, for instance a sequence of images, to obtain a scalable bit stream. The signal comprises blocks of values. Each block is represented as a sequence of bit planes and the values are scanned and transmitted in an order of decreasing bit plane significance. For each bit plane, scanning and transmitting are performed in a rectangular scan zone starting from a comer of the block. The produced bit stream is quantized to a desired bit rate by simply truncating the bit stream at a desired position.

A drawback of this method is that bit planes cannot be efficiently compressed using entropy codes like Run-Length Codes and Variable Length Codes, because they are not correlated enough. Consequently compression efficiency is obtained by transmitting the most significant values of the blocks first and by introducing hierarchical dependencies between values. This means that a decoder receiving the bit stream must take into account said hierarchical dependencies, which increases encoding and decoding delays. Moreover, since statistic of one and zeros within bit planes is random, entropy coding does not provide an efficient compression and large Look Up Tables (LUT) are needed. Consequently, a large memory capacity is required in order to store said LUTs. Another point is that due to hierarchical dependencies between values, the scanning order of the block values is no more known in advance by a decoder receiving the bit stream and parallel processing cannot be easily implemented.

Therefore, the decoding process is complex and costly and it cannot be easily accelerated.

### SUMMARY OF THE INVENTION

An object of the invention is to provide a method of encoding a signal to obtain a bit stream, which can be decoded in a simpler, quicker and cheaper way.

This is achieved with a method of encoding a signal into a bit stream, said signal comprising blocks of values, said method comprising the steps of:
applying a transformation to a block of values in order to get a transformed block, said transformed block comprising a number of coefficients, said number being greater than one,
scanning the coefficients of said transformed block according to a coefficient scanning order,
splitting a scanned coefficient into K groups of bits numbered from 1 to K, such that at least a group of bits comprises at least 2 bits and such that said scanned coefficient is the concatenation of the K groups of bits,
entropy coding a k^{th} group of bits using entropy codes into a k^{th} entropy coded group of bits,
forming a block bit stream from the K entropy coded groups of bits of the scanned coefficients of the transformed block, said output bit stream comprising said block bit stream.

An advantage of dividing a scanned coefficient into a number of groups of bits, said groups of bits generally comprising 2 or 3 bits, and of entropy encoding said groups of bits independently from each other, is that short entropy codes are needed. Another advantage is that less entropy codes are used. Consequently, not only the memory capacity needed for entropy codes Look Up Table (LUT), but also the number of memory accesses are reduced.

An advantage of forming groups of bits or bit planes compared with isolated bit planes, is that a correlation exists within the groups of bits. Consequently, entropy encoding achieves good compression efficiency and no reordering of the groups of bits is needed. Therefore, encoding and decoding operations are simply achieved in the scanning order, which is known in advance by any encoder or decoder.

Moreover the K groups of bits are independent from each other and entropy coding can be achieved in parallel, which allows accelerating the encoding process.

Consequently the method in accordance with the invention is simpler, cheaper and quicker.

The invention also relates to a method of decoding such an output bit stream.

In a first embodiment of the invention, the K entropy coded groups of bits of the scanned coefficient are grouped together to form an entropy coded coefficient and said block bit stream comprises a concatenation of said entropy coded coefficients. An advantage of said first embodiment of the invention is to be very simple.

In a second embodiment of the invention, said block bit stream comprises K entropy coded block layers, a k^{th} entropy code block layer comprising the k^{th} entropy coded groups of bits of the I scanned coefficients of the transformed block. The block bit stream is divided into K entropy coded block layers, which may be entropy decoded independently from each other. It is also possible not to decode all the entropy coded block layers, provided that the not decoded entropy coded block layers consist of less significant bits. An advantage of said second embodiment is therefore that it provides a Signal to Noise Ratio (SNR) scalability with K quality levels. No fine grain scalability is obtained, as it is the case with bit plane compression methods. An advantage of the second embodiment of the invention is to provide a trade-off between fine grain scalability and implementation costs.

The invention also relates to a video encoder, a video decoder and a video transcoder.

The invention is especially applicable in the field of low-cost, hardware video compression.

### BRIEF DESCRIPTION OF THE DRAWINGS

The invention will be further described with reference to the accompanying drawings:

FIG. 1a shows a flow chart diagram of the method of encoding a signal in accordance with a first embodiment of the invention,

FIG. 1b describes a possible structure of the output bit stream in accordance with a first embodiment of the invention,

FIG. 2 shows the step of splitting the coefficients of a transformed block into a plurality of groups of bits in accordance with the invention,

FIG. 3 shows a flow chart diagram of a decoding method in accordance with a first embodiment of the invention,

FIG. 4a shows a flow chart diagram of the method of encoding a signal in accordance with a second embodiment of the invention,

FIG. 4b describes a possible structure of the output bit stream in accordance with a second embodiment of the invention,

FIG. 5 shows a flow chart diagram of a decoding method in accordance with a second embodiment of the invention,

FIG. 6 describes in a functional way a video encoder in accordance with the second embodiment of the invention,

FIG. 7 describes in a functional way a video decoder in accordance with the second embodiment of the invention,

FIG. 8 describes in a functional way a video trans-coder in accordance with the second embodiment of the invention.

### DETAILED DESCRIPTION OF THE INVENTION

In the following, the method in accordance with the invention applies to a video signal comprising a sequence of images and implements an MPEG-like video compression scheme.

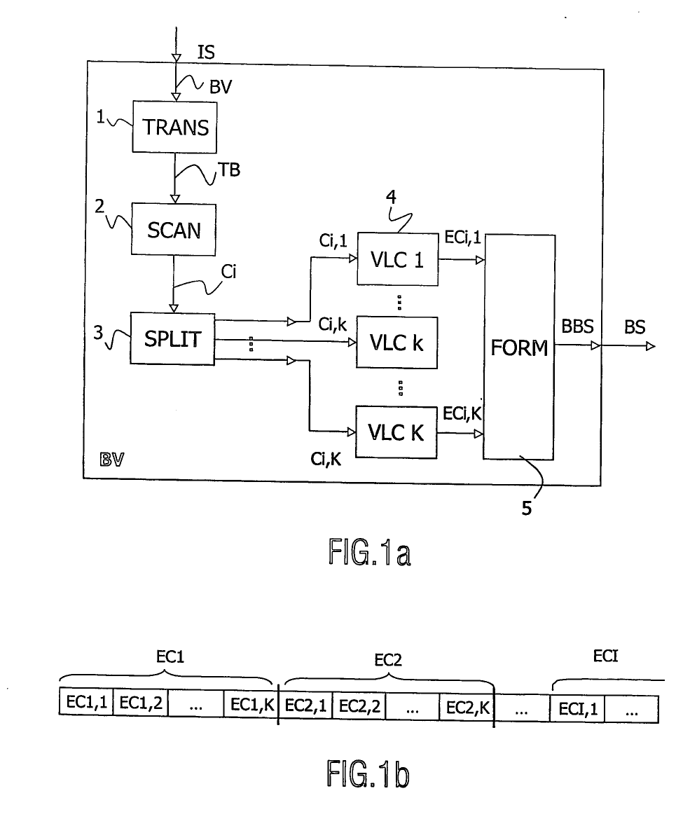

FIG. 1a presents a flow chart diagram of the method in accordance with the invention. A block of values of a signal IS, said block of values comprising 8×8 pixel values is transformed using a transformation 1, for instance the well-known Discrete Cosinus Transform (DCT). A transformed block TB is obtained. Said transformed block comprises I coefficients Cᵢ, where I is an integer greater than one and i is an integer included into the interval [1, I]. Said coefficients Cᵢ are scanned by a scanning step 2. The step 2 for instance achieves a zig-zag scanning of the coefficients Cᵢ of the transformed block, well known to those skilled in the art, is performed.

The method in accordance with the invention further comprises a step 3 of splitting a coefficient Cᵢ into K groups of bits, where K is an integer greater than one. Said K groups of bits are chosen such that at least one group of bits comprises at least 2 bits and such that said coefficient Cᵢ is obtained by concatenating the K groups of bits. In other words, K groups of contiguous bits are formed within the coefficient Cᵢ.

In the particular case of an MPEG-like video compression scheme, the coefficient Cᵢ comprises 11 bits and the step 3 splits the coefficient Cᵢ into 4 groups of bits, which are for instance: a first group C_{i,1} of 3 most significant bits, a second group C_{i,2} of 3 bits, a third group C_{i,3} of 3 bits and a fourth group C_{i,4} of 2 less significant bits.

The method in accordance with the invention further comprises a step 4 of encoding the K groups of bits using entropy codes. Said K groups of bits are entropy coded independently from each other. Said entropy codes are for instance Variable Length Codes (VLC). K entropy coded groups of bits EC_{i,1} to EC_{i,K} are obtained. The step 4 achieves a layered entropy coding of the coefficients C₁ to C_{I}.

Said K entropy coded groups of bits are put into a block bit stream BBS by a forming step 5.

An output bit stream BS is finally formed from the block bit streams of the blocks of values included into the input signal.

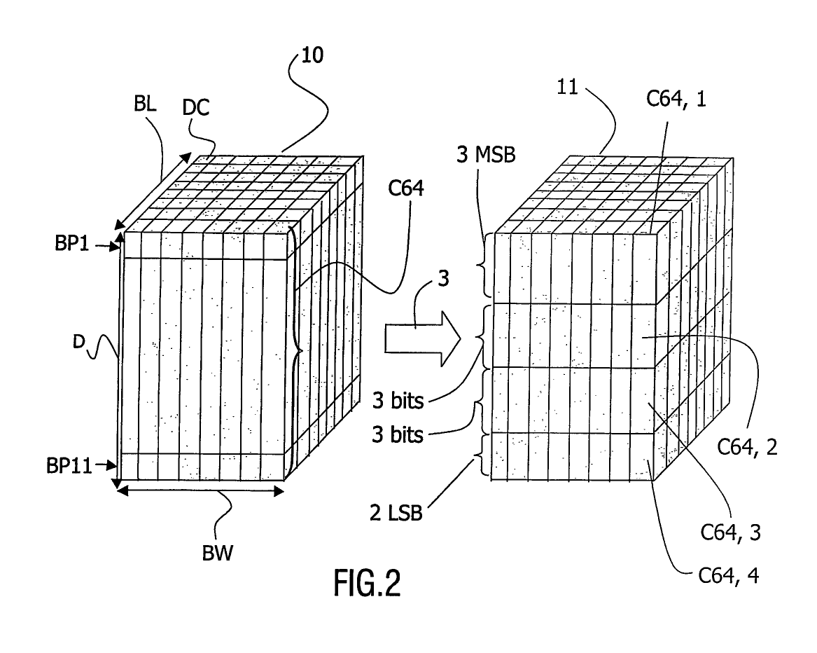

FIG. 2 describes the splitting step 3 of a DCT block 10 into a split block 11 in accordance with the first embodiment of the invention. Said DCT block 10 is represented as a rectangular parallelepiped having a width BW of 8 coefficients, a length BL of 8 coefficients and a depth D of 11 bit planes BP₁ to BP₁₁. The first coefficient C₁, also called Direct Component coefficient, represents an average value of the signal. The other coefficients C₂ to C₆₄ are frequency components of the signal. The step 3 splits a coefficient Cᵢ into four groups of bits C_{i,1}, C_{i,2}, C_{i,3}, C_{i,4}. Referring to FIG. 2, for the coefficient C₆₄, first group of bits C_{64,1} comprises 3 bits, which are the three Most Significant Bits (MSB), second group of bits C_{64,2} comprises 3 bits, third group of bits C_{64,3} comprises 3 bits and fourth group of bits C_{64,4} comprises 2 Least Significant Bits (LSB).

Step 4 encodes a k^{th} group of bits C_{i,k} using entropy codes like VLCs into entropy coded groups of bits EC_{i,k}. A Look Up Table (LUT) is used, which takes into account some statistics of the block bit stream BBS, for instance related to the type of blocks or the type of frame, the blocks come from.

It should be noted that a VLC LUT of a conventional MPEG-like coder can be used.

A k^{th} group of bit, where k is an integer included into the range [1, K], consisting of 3 bit planes, can be encoded by a Huffman variable length coder using a LUT comprising at least height words. As a matter of fact, there 2³=8 possible words with a 3 bit length. Therefore, for lossless coding of complete 11 bit coefficients Cᵢ using VLC LUTs, 8+8+8+4=28 words in total are needed.

It should be noted that conventional Huffman variable length coding of 11 bit DCT coefficients requires a LUT comprising 2¹¹=2048 words. Consequently, only a small part of a standard VLC LUT is effectively used. An advantage of the method according to the invention is therefore to allow using, storing and accessing much shorter LUTs.

It should also be noted that conventional Huffman coding of 11-bit length DCT coefficients provides words with a maximum length of 2¹¹−1=2047 bits. In the first embodiment of the invention, the maximum length of a coefficient of a block bit stream using 3 bit planes is 2³−1=7 bits and the maximum length of a coefficient of a block bit stream using 2 bit planes is 2²−1=3 bits. The 11-bit length DCT coefficient therefore maybe encoded using only 7+7+7+3=24 bits.

Transformed coefficients may have positive or negative values. Therefore the MSB group of bits usually includes a sign bit. In this case said sign bit is encoded in the same way as magnitude bits. However, it should be noted that sign bits may also be encoded independently from magnitude bits.

In conventional MPEG-like coders, an End of Block (EoB) symbol is inserted into the bit stream just after the last non-zero coefficient, in order to indicate that all subsequent coefficients in the scanning order are zeros. With the invention, a DCT block is divided into a plurality of block layers, also called bit-plane layers. Consequently, MSB layers have smaller numbers of non-zero coefficients, thus EOB symbol for this layer is inserted earlier in the bit stream, than it would have been if complete original DCT coefficients are scanned. Therefore, less zero coefficients are transmitted and compression efficiency is improved.

It has been mentioned above that the method of encoding a signal in accordance with the invention could use a fraction of the LUT of a conventional coder. It should be noted that a specific reduced size LUT may also be designed. Such a LUT may include statistics of previously encoded blocks of values. For example, if a neighboring DCT block only comprises DCT coefficients with small values, then the probability that the current block also comprises small values is high. This information may be used in the following ways:
the size of the layer with most significant bits is increased from 3 bits to 4 or 5 bits. In this case a longer run of zeros in this layer will be encoded more efficiently,
the LUT is reconstructed by allocating short code words to values with small magnitude (they have higher probability), and longer code words to values with big magnitude, because their probability is low.

Another kind of LUT may be specifically designed, which depends on statistics of previously encoded higher significant layers, which belong to the same DCT block. If higher significant layer comprises a lot of zeros, then the probability that lower significant layer also includes a long runs of zeros is high.

No quantization of the coefficients is required as it is the case for conventional MPEG-like coders. It is an advantage in terms of simplification of the encoding process. Moreover, no quantization parameter needs to be included into the bit stream. However a quantization step may be added to the encoding method in accordance with the invention in order to reduce the number of bit planes to be encoded.

Instead of introducing a quantization step of the coefficients of a transformed block, it is also possible to bit shift certain coefficients depending on their location in the DCT block. For instance, coefficients, which are considered as strongly contributing to perceptual quality of the decoded signal, are bit shifted in order to shift non-zero values to their MSB groups of bits. In this way, they will contribute to the decoded signal even if only the first entropy coded block bit stream is decoded.

In a first embodiment of the invention, the step 5 of forming the block bit stream BBS consists in grouping together the K entropy coded groups of bits of the scanned coefficient Ci into an entropy coded coefficient ECi and in forming said block bit stream as a concatenation of said entropy coded coefficients. FIG. 1b describes a possible structure of the obtained block bit stream BBS. An encoded coefficient ECᵢ is formed by concatenating the K entropy coded groups of bits EC_{i,1} to EC_{i,K}. The output bit stream BS is very similar to a conventional bit stream.

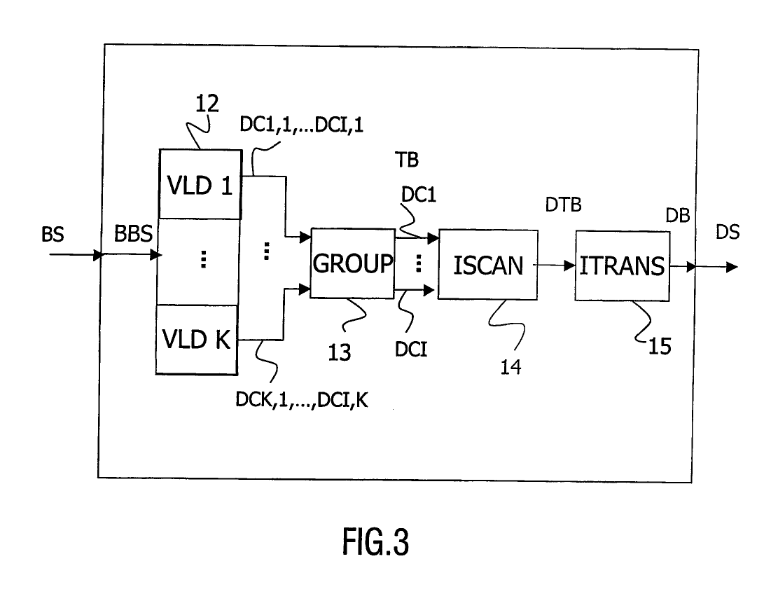

FIG. 3 presents a flow chart diagram of a decoding method in accordance with a first embodiment of the invention. A bit stream BS is received, which comprises a block bit stream BBS. Said block bit stream is entropy decoded by a step 12 of layered entropy decoding, which comprises a plurality of parallel entropy decoding sub steps. As a matter of fact, the block bit stream BBS in accordance with the first embodiment of the invention comprises entropy coded groups of bits EC_{i,1} to EC_{i,K}, which can be decoded independently and in parallel. Entropy decoded groups of bits Dc_{i,1} to DC_{i,K} are output, which are grouped by a grouping step 13 into a decoded coefficient DCᵢ. An inverse scanning step 14 then allows forming a transformed block DTB from I decoded coefficients DC₁ to DC_{I}. Said transformed block DTB is further inversely transformed by an inverse transformation step 15 into a decoded block of values DBV. Steps of layered entropy decoding, grouping, inverse scanning and inverse transformation are repeated for all the groups of bits forming the received bit stream BS, in order to supply a decoded signal DS, for instance a decoded image, comprising decoded blocks of values DBV.

An advantage of this first embodiment of the invention is to simplify encoding and decoding processes. As a matter of fact, reduced size LUTs are used by the layered entropy coding and decoding steps 4 and 12, which enables to limit the amount of stored data and the number of memory accesses. Besides, layered entropy encoding and decoding may be easily parallelized. Since only one entropy coded block bit stream is issued, this second embodiment is intended to non-scalable applications, where memory and time savings are a crucial point, like portable low-cost applications.

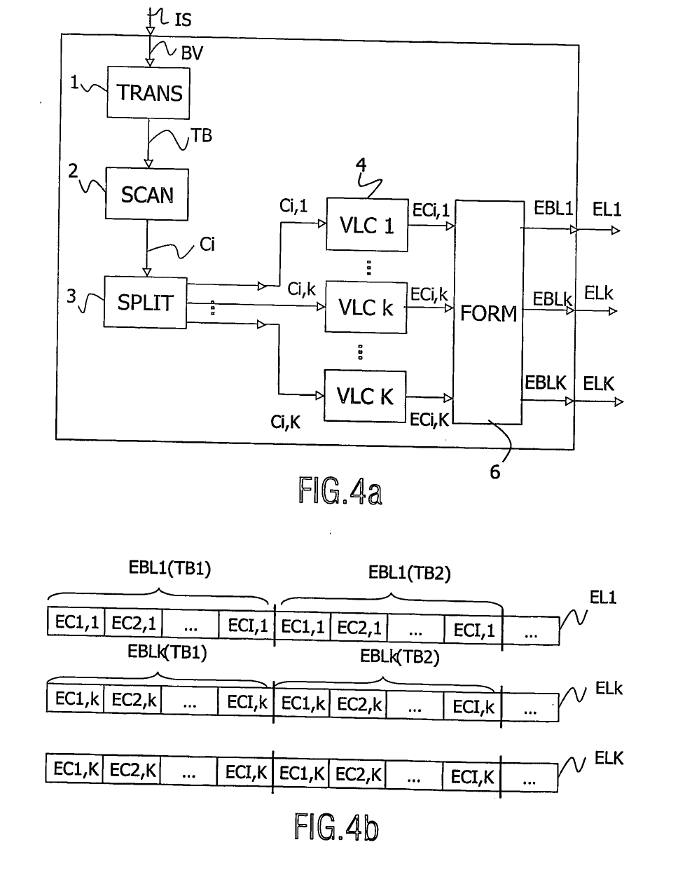

FIG. 4a presents a flow chart diagram of an encoding method in accordance with a second embodiment of the invention. Compared with the first embodiment of the invention, the step 5 is replaced by a step 6 of forming a block bit stream BBS consisting in K entropy coded block layers EBL₁ to EBL_{K}, a k^{th} entropy coded block layer EBLₖ comprising the k^{th} entropy coded groups of bits EC_{1,k} to EC_{I,k} of the I scanned coefficients of the transformed block (TB). FIG. 4b describes a possible structure of the entropy coded block layers EBL₁ to EBL_{K} forming the block bit stream BBS. The first entropy coded block layer EBL₁ comprises the entropy coded MSB groups of bits of the I coefficients of the transformed block TB. Said first block layer EBL₁ constitutes a base block layer, which can be decoded independently from the other block layers and provides a first level of quality of the input signal. The k^{th} entropy coded block layer EBLₖ comprises the k^{th} entropy coded groups of bits of the I coefficients of the transformed block TB. Said k^{th} block layer EBL₁ constitutes a k^{th} quality level of the input signal. Consequently, the second embodiment in accordance with the invention provides a Signal To Noise Ratio scalability for a block of values of an input signal.

It should be noted that there are several ways of building the output bit stream BS from the block bit streams BBS. In a third embodiment of the invention, illustrated by FIG. 4b, the output block bit stream BS comprises a plurality K of encoded layers L₁ to L_{K}. Such an encoded layer Lₖ is formed by concatenating the entropy coded block layers EBLₖ corresponding to the consecutive blocks of values of the input signal IS. Consequently the first encoded layers L₁ comprises the first encoded groups of bits of the blocks of values of the input signal IS. Said first encoded layer L₁, which can be decoded independently from the other encoded layers L₂ to L_{K} constitutes a base layer and provides a decoded signal DS with a first or basic level of quality. The L_{K} encoded layer is intended to improve the SNR quality level of the decoded signal obtained from the k−1 first layers L₁ to Lₖ₋₁.

An alternative way of building the output bit stream BS is to form block bit streams BBS by concatenating the entropy coded block layers EBL₁ to EBL_{K} of blocks of values BV and to concatenate these block bit streams BBS.

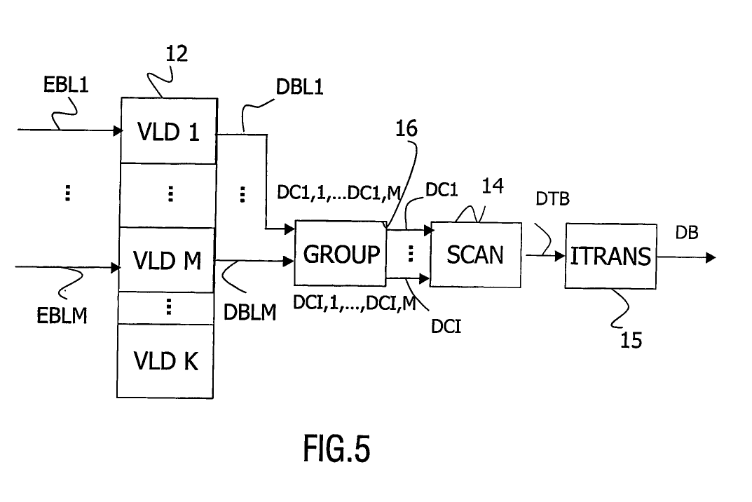

FIG. 5 presents a flow chart diagram of a decoding method in accordance with the second embodiment of the invention. A plurality of entropy coded block layers EBL₁ to EBL_{M}, where M is an integer lower than K, are received by a step 12 of layered entropy decoding. Entropy decoded groups of bits DC_{1,m} to DC_{I,m} are output for a block layer EBLₘ, where m is an integer included into the range [1,M]. A decoded coefficient is then formed by a grouping step 16, which groups the M decoded groups of bits DC_{i,1} to DC_{i,M} corresponding to a decoded coefficient ECi. An inverse scanning step 14 reorders the I decoded coefficients to form a decoded transformed block DTB. Said decoded transformed block is further inversely transformed by an inverse transformation step 5 into a decoded block of values BV. Steps 12 of layered entropy decoding, 16 of grouping the entropy decoded groups of bits, 14 of inverse scanning and 15 of inverse transformation are repeated for all the entropy coded groups of bits of the received entropy coded block layers. Decoded block of values are output which form a decoded signal. Said decoded signal DS has a SNR quality level, which depends on the amount M of received entropy coded block layers.

An advantage of the second embodiment of the invention is to provide a layered SNR scalability combined with a simplification of the encoding and decoding processes.

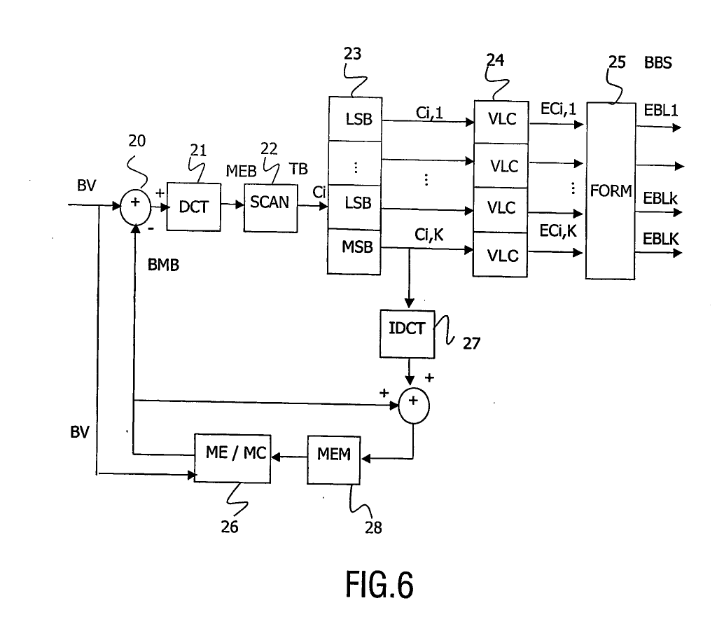

FIG. 6 shows a schematic block diagram of a SNR scalable video encoder according to the second embodiment of the invention. Such a SNR scalable video encoder aims at encoding an input video signal comprising a sequence of frames, a frame comprising blocks of values BV, and to output an output bit stream BS. A block of values BV is transformed into a transformed block TB by transformation means 21 applying for instance a DCT transform. Said transformed block TB comprises I coefficients C₁ to C_{I}, which are scanned by scanning means 22 and split into K groups of bits by split means 23. Said K groups of bits are further VLC encoded into K VLC coded groups of bits EC_{i,1} to EC_{i,K} by VLC means 24. A layered block bit stream is formed by forming means 25 from said K VLC coded groups of bits EC_{i,1} to EC_{i,K}. Said block bit stream comprises K encoded block layers EBL₁ to EBL_{K}. Such an encoding process is repeated for each block of values BV and the consecutive block bit streams contribute to form the output bit stream BS.

The video encoder of FIG. 6 comprises a motion estimation and compensation module 26, as MPEG-like encoders usually do. The motion estimation and compensation (ME/MC) module 26 firstly matchs the block of values BV, which belongs to a current frame of the input video sequence with a block, referred to as the best match block of a previous or next frame, called reference frame, in accordance with similarity criteria. The ME/MC module 26 then calculates a displacement between the current block of values and the best match block. A motion vector is obtained, which has to be inserted into one of block layers, preferably EBL₁. A matching error block MEB is calculated by subtracting the best match block BMB to the current block of values BV using a subtraction operator 20. Said matching error block MEB is handled by the transformation module 21 instead of the input block of values BV. Such an encoding scheme is called an inter-frame encoding scheme, which consists in encoding a current frame differentially with respect to a previously encoded frame. Said inter-frame encoding scheme has proven to bring up improved compression efficiency compared with intra-frame encoding schemes, which encode each frame independently without exploiting redundancy between subsequent frames of a video signal. It should be noted that the invention is not limited to motion compensated video encoders, but relates to any block-based video encoder.

Since said best match block has already been processed by the video encoder, it is no more available as a block of values. It is therefore provided by an inverse transformation module 27, which reconstructs the best match block from its LSB coefficients C_{1,1} to C_{I,1} from DCT coefficients of a reference frame stored in a memory 28. It should be noted that only the MSB coefficients are used to reconstruct the best match block, because in a SNR scalable scheme, it is not possible to know in advance which layers the decoder will effectively receive. Consequently, in order to avoid introducing a drift error in the decoder, motion compensation is made using only the first, also called base, entropy coded block layer EBL₁, which corresponds to the part of the SNR scalable bit stream that a decoder will at least receive.

It should be noted that motion vectors related to a block of value are included into the corresponding first block layer EBL₁.

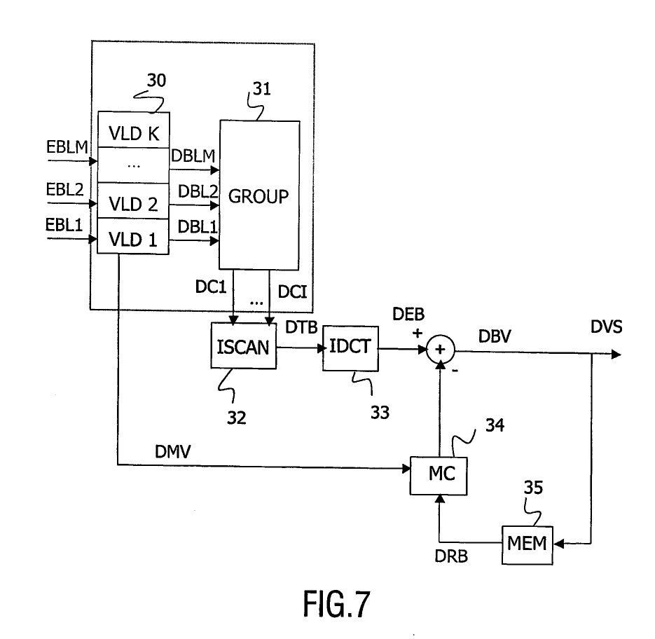

FIG. 7 shows a schematic block diagram of a SNR scalable video decoder according to the second embodiment of the invention. Some entropy coded block layers EBL₁ to EBL_{M}, where M is an integer not greater than K, are received at the decoder side. Said entropy coded block layers are firstly Variable Length Decoded (VLD) by VLD means 30 in order to provide M decoded block layers DBL₁ to DBL_{M}. As already mentioned above when describing FIG. 3, said VLD means 30 comprise K VLDₖ sub means, which can be implemented by parallel processors.

A decoded block layers DBLₘ, with m included into the range [1,M], comprises a concatenation of mth groups of bits, each mth group of bits belonging to a decoded coefficient DC_{i,m} of a transformed block TB. The decoder comprises Grouping means 31 for putting together the groups of bits DC_{i,1} to DC_{i,,M} corresponding to a coefficient DCᵢ. Inverse scanning means 32 reorder the coefficients DC1 to DCI in order to form a decoded transform block. Said decoded transformed block DTB is a priori not similar to the transformed block TB obtained at the encoder side, because all the entropy coded block layers EBL₁ to EBL_{K} of the SNR scalable bit stream BBS output by the video encoder may not have been all transmitted to the video decoder.

The coefficients DCᵢ of the decoded transformed block DTB are inversely transformed by inverse transformation means 33 in order to provide a decoded error block DEB. Decoded motion vectors DMV are used by motion compensation means 34 to reconstruct a decoded block of values DBV from the decoded error bock DEB and a previously decoded reference block DRB stored in a memory 35.

A decoded video signal DVS is obtained with a visual quality proportional to the amount of the SNR scalable bit stream, which has been decoded.

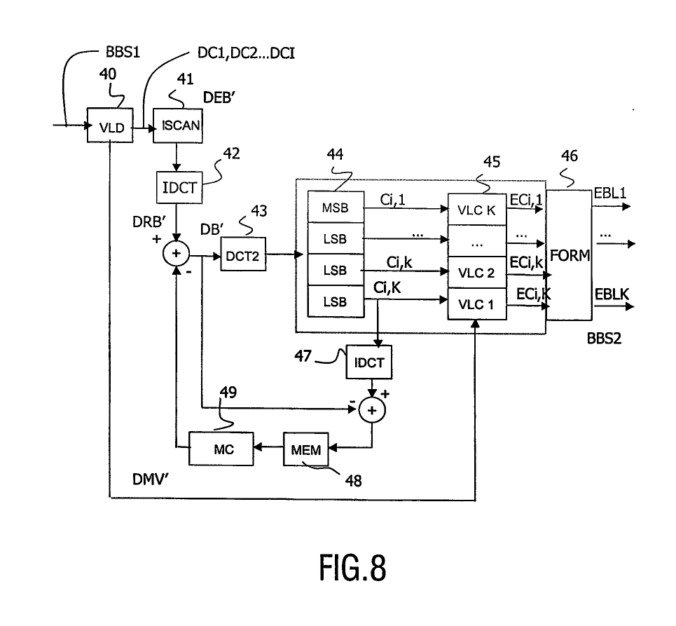

FIG. 8 shows a schematic block diagram of a SNR scalable video trans-coder according to the second embodiment of the invention. Such a trans-coder aims at decoding an input non-scalable block bit stream BBS and at converting said non-scalable block bit stream NSBBS into a plurality of entropy coded block layers EBL₁ to EBL_{K}. Said trans-coder comprises VLD means 40 for decoding the VLC codes of the input block bit stream BBS₁. Decoded coefficients are obtained, which are inversely scanned by inverse scanning means 41 to form a decoded transformed blocks DTB′. Said decoded transformed block is inversely transformed by inverse transformation means 42 into a decoded error block DEB′. Said decoded error block is summed to a previously decoded reference block DRB′ using decoded motion vectors DMV′. A decoded block of values DBV′ is obtained, which is further encoded using a SNR scalable encoder similar as the one presented in FIG. 6. K entropy encoded block layers EBL₁ to EBL_{K} are obtained.

It should be noted that the above-mentioned embodiments illustrate rather than limit the invention, and that those skilled in the art will be able to design many alternative embodiments without departing from the scope of the appended claims. In the claims, any reference signs places between parentheses shall not be construed as limiting the claims. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. A method of encoding an input signal into an output bit stream (BS), said input signal comprising blocks of values, said method comprising the steps of:
applying (1) a transformation to a block of values (BV) in order to get a transformed block (TB), said transformed block comprising a number (I) of coefficients, said number being greater than one,
scanning (2) the coefficients (C₁-C_{I}) of a transformed block (TB) according to a coefficient scanning order,
splitting (3) a scanned coefficient (Cᵢ) into K groups of bits (C_{i,1}-C_{i,K}) numbered from 1 to K, such that at least a group of bits comprise at least 2 bits and such that said scanned coefficient (Cᵢ) is the concatenation of the K groups of bits,
entropy coding (4) a k^{th} group of bits (C_{i,k}) using entropy codes into a k^{th} entropy coded group of bits (EC_{i,k}),
forming (5) a block bit stream (BBS) from the K entropy coded groups of bits of the scanned coefficients of the transformed block, said output bit stream (BS) comprising said block bit stream (BBS).

2. A method of encoding a signal as claimed in claim 1, wherein said entropy codes are Variable Length Codes.

3. A method of encoding a signal as claimed in claim 1, wherein the K entropy coded groups of bits (EC_{i,1}-EC_{i,k}) of the scanned coefficient Cᵢ are grouped together to form an entropy coded coefficient (ECᵢ) and said block bit stream (BBS) comprises a concatenation of said entropy coded coefficients.

4. A method of encoding a signal as claimed in claim 1, wherein said block bit stream (BBS) comprises K entropy coded block layers (EBL₁-EBL_{K}), a k^{th} entropy coded block layer (EBLₖ) comprising the entropy codes of the k^{th} groups of bits of the I scanned coefficients of the transformed block (TB).

5. A method of encoding a signal as claimed in claim 4, wherein said output bit stream (BS) comprises K layers (L₁-L_{K}), a layer (Lₖ) comprising a concatenation of the k^{th} entropy coded block layers (EBLₖ) corresponding to successively scanned blocks of values of the input signal.

6. A method of decoding a bit stream (BS) comprising block bit streams into a decoded signal, a block bit stream (BBS) comprising entropy coded coefficients (ECᵢ), said entropy coded coefficients comprising entropy coded groups of bits (EC_{i,1}-EC_{i,K}), said method comprising steps of:
entropy decoding (12) said entropy coded groups of bits (EC_{i,1}-EC_{i,K}) into entropy decoded groups of bits (DC_{i,1}-DC_{i,K}),
grouping (13) said entropy decoded groups of bits (DC_{i,1}-DC_{i,K}) into a decoded coefficient (DCᵢ),
inversely scanning (14) said decoded coefficients (DC₁-DC_{I}) to form a decoded transformed block (DTB),
applying (15) an inverse transformation to said decoded transformed block (DTB) in order to get a decoded block (DB), said decoded signal comprising decoded blocks.

7. A method of decoding a plurality of entropy coded block layers (EBL₁-EBL_{K}) into a decoded signal, said method comprising steps of:
entropy decoding a k^{th} entropy coded block layer (EBLₖ) into a k^{th} entropy decoded block layer (DBLₖ), said k^{th} entropy decoded block layer comprising k^{th} decoded groups of bits (DC_{i,k}),
grouping first to K^{th} decoded groups of bits, in order to form decoded coefficients (DCᵢ),
inversely scanning (14) said decoded coefficients (DC₁-DC_{I}) to form a decoded transformed block (DTB),
applying an inverse transformation to decoded transformed block (DTB) in order to get a decoded block (DB), said decoded signal comprising decoded blocks.

8. A video encoder for encoding a sequence of images, said images comprising blocks, said video encoder comprising means for:
applying a transformation to a block of values (BV) in order to get a transformed block (TB), said transformed block comprising a number (I) of coefficients, said number (I) being greater than one,
scanning the coefficients (C₁-C_{I}) of a transformed block (TB) according to a coefficient scanning order, a scanned coefficient (Cᵢ) comprising a number (N) of bits, said number (N) being greater than one,
splitting a scanned coefficient (Cᵢ) into a number (K) groups of bits (C_{i,1}-C_{i,K}) numbered from 1 to K, said number (K) being greater than one, such that at least a group of bits comprises at least 2 bits and such that said scanned coefficient (Cᵢ) is the concatenation of the K groups of bits,
encoding said k^{th} groups of bits into k^{th} entropy coded groups of bits (EC_{i,1}-EC_{i,K}) using entropy codes.
forming a block bit stream (BBS) from the entropy codes, said bit stream (BS) comprising said block bit stream (BBS).

9. A video decoder for delivering a sequence of decoded images by decoding a bit stream (BS) comprising block bit streams, said block bit stream (BBS) comprising entropy coded coefficients (ECᵢ) comprising a number (K) of entropy coded groups of bits (EC_{i,1}-EC_{i,K}), said method comprising steps of:
entropy decoding (30) said entropy-coded groups of bits (EC_{i,1}-EC_{i,K}) into entropy decoded groups of bits (DC_{i,1}-DC_{i,K}), said entropy decoded groups of bits forming decoded coefficients (DCᵢ),
grouping (31) first to K^{th} decoded groups of bits, in order to form decoded coefficients
inversely scanning (32) said decoded coefficients (DC₁-DC_{I}) to form a decoded transformed block (DTB),
applying an inverse transformation (33) to said decoded transformed block (DTB) in order to get a decoded block (DB), said decoded image comprising said decoded block.

10. A video decoder as claimed in claim 9, wherein said K received entropy coded groups of bits (EC_{i,1}-EC_{i,K}) are decoded by K parallel decoding means.

11. A video trans-coder for trans-coding a first bit stream (BS1) into a second bit stream (BS₂), said first bit stream (BS₁) comprising first block bit streams, a first block bit stream (BBS₁) comprising entropy coded first transformation coefficients (T₁Cᵢ), said video trans-coder comprising means for:
decoding (40) said entropy coded first transformation coefficients into entropy decoded first transformation coefficients (DCᵢ),
inversely scanning (41) said decoded coefficients (DC₁-DC_{I}) to form a decoded transformed block (DTB′),
applying (42) an inverse first transformation to the entropy decoded first transformation coefficients in order to get a decoded block (DB″),
applying (43) a second transformation to said decoded block (DTB) in order to get second transformation coefficients (Cᵢ), a second transformation coefficient comprising N bits,
splitting (44) said second transformation coefficient (Cᵢ) into K groups of bits numbered from 1 to K, such that at least one group of bits comprises at least 2 bits and such that said second transformation coefficient is obtained by concatenating the K groups of bits,
entropy coding (45) said k^{th} groups of bits using entropy codes,
forming said second block bit stream (BBS₂) from the entropy codes, said second bit stream (BS₂) comprising said second block bit stream (BBS₂).

12. A computer program comprising a set of instructions which, when loaded into a processor or a computer, causes the processor or the computer to carry out the method as claimed in claim 1.

13. A signal carrying a program as claimed in claim 12.
